(19) United States
(12) Patent Application Publication
(10) Pub. No.: US 2014/0111161 A1
(43) Pub. Date: Apr. 24, 2014

(54) BATTERY PACK

(71) Applicant: SAMSUNG SDI CO., LTD., Yongin-si (KR)

(72) Inventor: Young-Il KIM, Yongin-si (KR)

(73) Assignee: SAMSUNG SDI CO., LTD., Yongin-si (KR)

(21) Appl. No.: 13/796,508

(22) Filed: Mar. 12, 2013

(30) Foreign Application Priority Data
Oct. 24, 2012 (KR) 10-2012-0118668

(51) Int. Cl. H02J 7/00; H01M 10/42

(52) U.S. Cl. CPC H02J 7/0029; H01M 10/425; H02J 7/0068
USPC 320/128

(57) ABSTRACT

A battery pack including: a battery unit; a diode unit on charge and discharge pathways to control power flow of the charge and discharge pathways; and an insulating wall between the battery unit and the diode unit and mutually insulating the battery unit and the diode unit.

### CROSS-REFERENCE TO RELATED APPLICATION

This application claims priority to and the benefit of Korean Patent Application No. 10-2012-0118668, filed on Oct. 24, 2012 in the Korean Intellectual Property Office, the entire content of which is incorporated herein by reference.

### BACKGROUND

1. Field

Aspects of embodiments of the present invention relate to a battery pack.

2. Description of the Related Art

Unlike a primary battery that is not able to charge, a secondary battery is able to charge and discharge. A secondary battery is used as an energy source, such as for a mobile electronic device, an electric vehicle, a hybrid vehicle, an electric bicycle, an uninterruptible power supply, or the like. Depending on a type of external device to which a secondary battery is applied, a secondary battery may be used in the form of a single battery cell or a battery pack that is enclosed in a single unit by connecting a plurality of battery cells to each other.

A small mobile device such as a mobile phone may operate in a given period of time based on output and capacity of a single battery cell, but in the case of an electric vehicle and a hybrid vehicle that have a high power consumption, a long-term and a high-power driving are required, and thus, a battery pack is preferred for the problems of the output and the capacity thereof. In addition, a battery pack may increase an output voltage or an output current depending on a number of included battery cells.

### SUMMARY

According to an aspect of embodiments of the present invention, a battery unit includes an insulation structure between charge and discharge pathways where high current flows which prevents or substantially prevents damage of the battery unit.

According to an embodiment of the present invention, a battery pack includes: a battery unit; a diode unit on charge and discharge pathways to control power flow of the charge and discharge pathways; and an insulating wall between the battery unit and the diode unit and mutually insulating the battery unit and the diode unit.

The insulating wall may be relatively closer to the battery unit than to the diode unit.

The insulating wall may contact the battery unit.

The insulating wall may surround the battery unit.

The insulating wall may surround an end of the battery unit facing the diode unit and opposite side surfaces of the battery unit.

The insulating wall may include an extension portion surrounding the opposite side surfaces of the battery unit, and the opposite side surfaces may include a heat-radiating hole.

The insulating wall may be coupled to an end plate at another end of the battery unit opposite the end of the battery unit facing the diode unit.

The insulating wall and the end plate may be mutually coupled to surround an outer circumference of the battery unit.

The insulating wall and the end plate may surround four side surfaces of the battery unit formed in a rectangular shape.

The end plate may include: a base plate facing the another end of the battery unit; and a flange unit bent in a direction opposite to the battery unit at an edge of the base plate.

The flange unit and the insulating wall may overlap each other and may be mutually fastened by a fastening member.

The battery unit and the diode unit may be spaced apart from each other by a separation gap.

The battery unit and the diode unit may be assembled on a base frame.

The diode unit may include: at least one charge diode formed on the charge pathway of the battery unit; and at least one discharge diode formed on the discharge pathway of the battery unit.

The battery pack may further include a battery management system (BMS) to control charge and discharge operations of the battery unit.

The BMS may be at a side of the battery unit, and the diode unit may be at another side of the battery unit opposite to the BMS.

The BMS may be on an end plate that is at an end of the battery unit.

The insulating wall may be formed of galvanized steel sheet.

### BRIEF DESCRIPTION OF THE DRAWINGS

The above and other features and aspects of the present invention will become more apparent by describing in further detail some exemplary embodiments thereof with reference to the attached drawings, in which:

FIG. 1 is an exploded perspective view of a battery pack according to an embodiment of the present invention;

FIG. 2 is a top view of the battery pack of FIG. 1;

FIG. 3 is an exploded perspective view of a battery unit and a BMS of the battery pack of FIG. 1; and

FIG. 4 is an exploded perspective view of a diode unit of the battery pack of FIG. 1.

### DETAILED DESCRIPTION

Reference will now be made in detail to some exemplary embodiments of the present invention, examples of which are illustrated in the accompanying drawings, wherein like reference numerals refer to the like elements throughout. However, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art. As those skilled in the art would realize, the described embodiments may be modified in various ways, all without departing from the spirit or scope of the present invention. Expressions such as “at least one of,” when preceding a list of elements, modify the entire list of elements and do not modify the individual elements of the list.

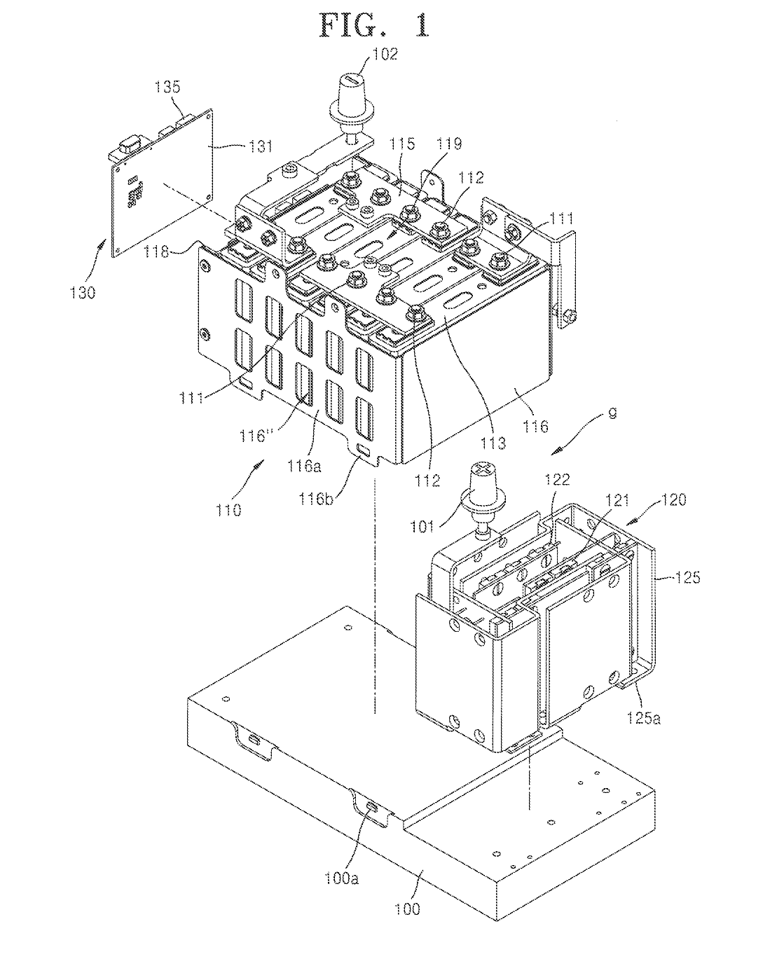

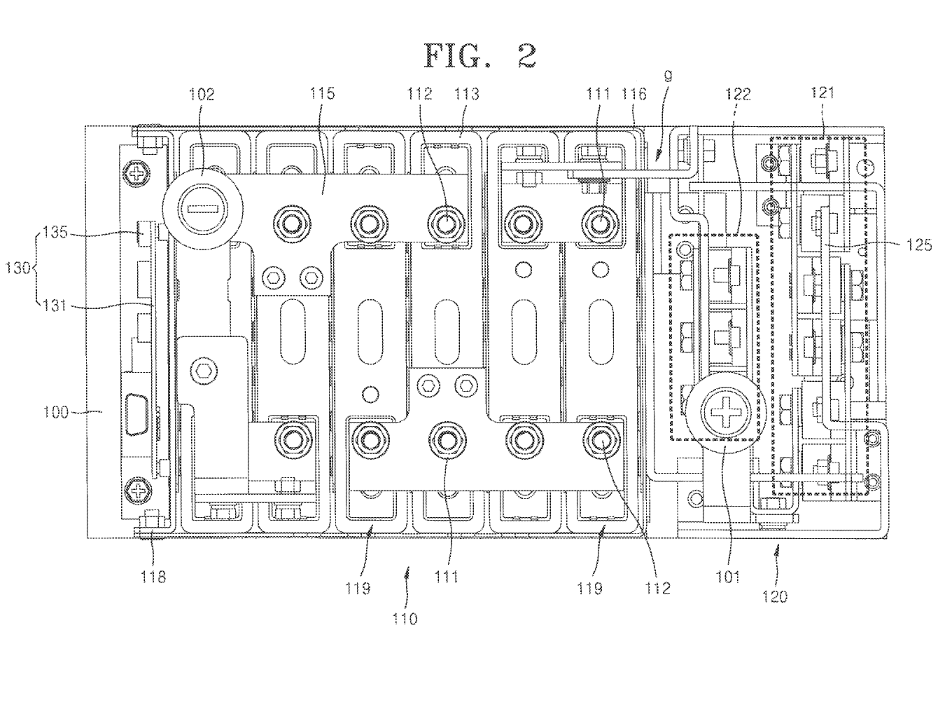

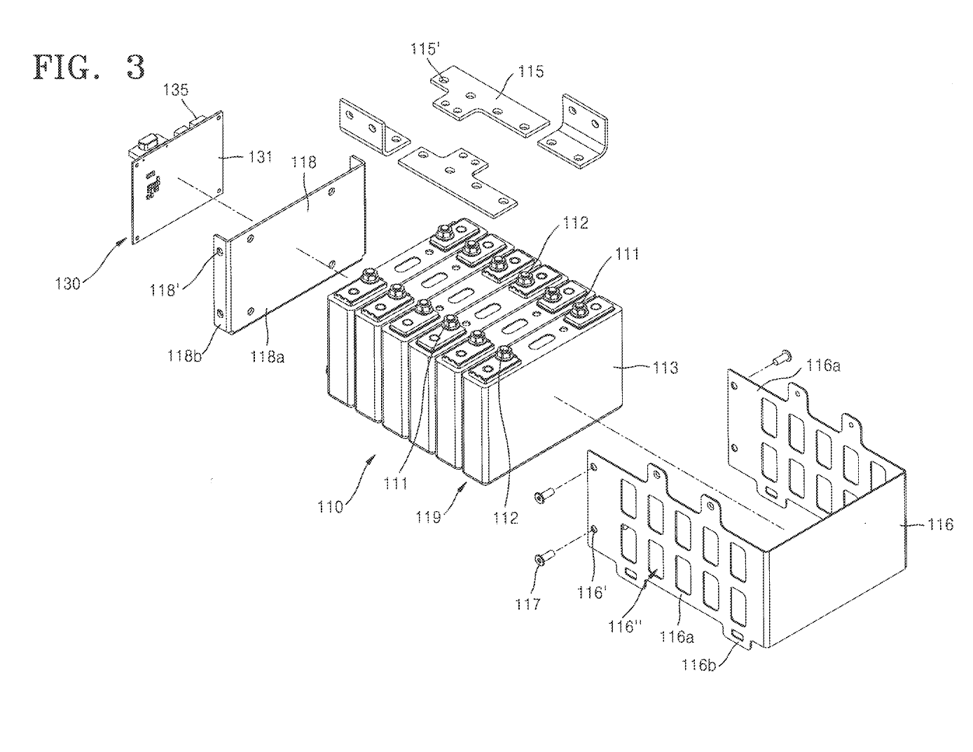

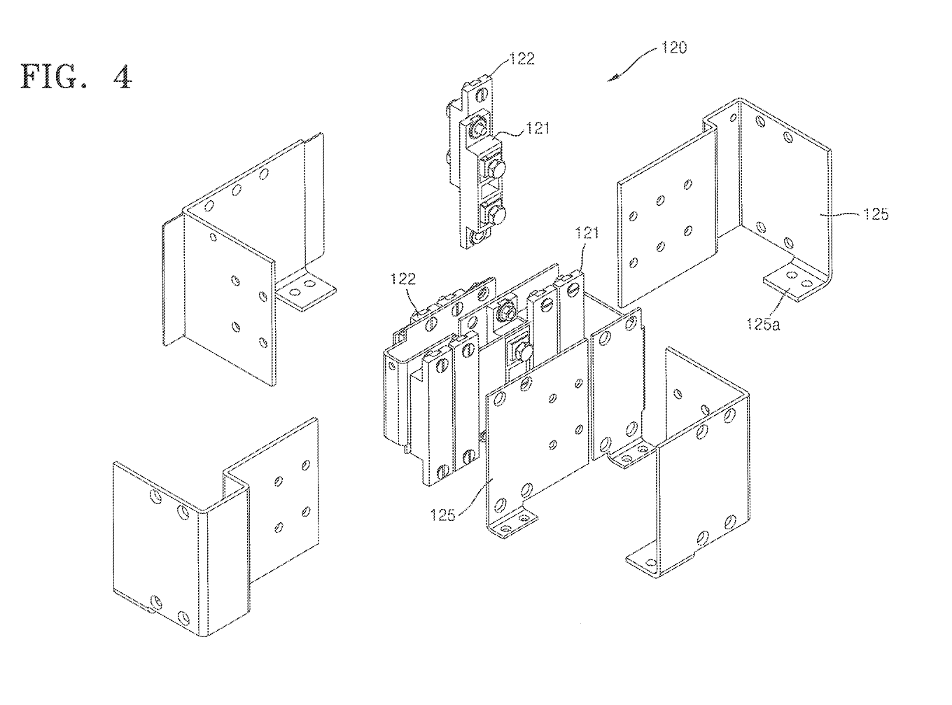

FIG. 1 is an exploded perspective view of a battery pack according to an embodiment of the present invention: and FIG. 2 is a top view of the battery pack of FIG. 1. FIG. 3 is an exploded perspective view of a battery unit and a battery management system (BMS) of the battery pack of FIG. 1; and FIG. 4 is an exploded perspective view of a diode unit of the battery pack of FIG. 1.

Referring to FIGS. 1 and 2, a battery pack according to an embodiment of the present invention includes a battery unit 110, a diode unit 120 disposed on charge and discharge pathways of the battery unit 110, and a BMS 130 to monitor a status of charge and discharge and to control charge and discharge operations.

Referring to FIG. 3, the battery unit 110 may include a plurality of battery cells 119 connected in series and parallel and may manipulate connection in series and parallel to adjust rated charge voltage and charge capacity. In one embodiment, for example, the battery unit 110 may include a plurality of battery cells 119 connected in series and parallel such that a voltage is 12.6 V. In one embodiment, the battery unit 110 may have a configuration of three battery cells 119, each with a voltage of 4.2 V, connected in series to have the voltage of 12.6 V. In one embodiment, for example, two neighboring battery cells 119 are connected in parallel and three pairs of the neighboring battery cells 119 are connected in series, such that the battery unit 110 may have the voltage of 12.6 V.

A secondary battery such as a lithium-ion battery may be used as the battery cells 119, and a prismatic type of a secondary battery formed in a roughly rectangular shape may be applied as described above; however, the present invention is not limited thereto. For example, various types of a secondary battery such as a cylinder-type secondary battery may be applied, but the present invention is not limited thereto.

In one embodiment, for example, each of the plurality of battery cells 119 may include a battery case 113, an electrode assembly (not shown) that is accommodated inside the battery case 113, and electrode terminals 111 and 112 that are electrically connected with the electrode assembly to be exposed to the outside. For example, the electrode terminals 111 and 112 may form an upper portion of each of the battery cells 119. In addition, the electrode terminals 111 and 112 may be exposed to the outside of the battery case 113.

The electrode terminals 111 and 112, in one embodiment, are formed on right and left sides of each of the battery cells 119, respectively, and may include a first and a second electrode terminal 111 and 112 having a polarity opposite to each other. Depending on the configuration of the plurality of battery cells 119, the plurality of neighboring battery cells 119 may be disposed on the same side or on the opposite side to each other. For example, the plurality of neighboring battery cells 119 that are connected in parallel may be disposed in the same orientation, and accordingly, the first and the second electrode terminals 111 and 112 of each of the plurality of neighboring battery cells 119 may be disposed on the same left side or the same right side. The plurality of neighboring battery cells 119 that are connected in series may be disposed in the left-right reversed orientation, and accordingly, the first and the second electrode terminals 111 and 112 of each of the plurality of neighboring battery cells 119 may be disposed on the opposite left side or on the opposite right side. Each of the plurality of neighboring battery cells 119 may be connected in parallel or in series through a bus bar 115 that extends in one direction along the array direction of the plurality of battery cells 119.

The battery unit 110, in one embodiment, includes the bus bar 115 that connects the plurality of battery cells 119 in series and parallel. The bus bar 115 is extended across the plurality of battery cells 119 to connect the first and the second electrode terminals 111 and 112 of each of the plurality of battery cells. For example, the plurality of neighboring battery cells 119 along the array direction thereof are electrically connected to each other through coupling to the electrode terminals 111 and 112, and the electrode terminals 111 and 112 may be connected in series or in parallel. As such, the neighboring electrode terminals 111 and 112 may be electrically connected by the bus bar 115.

In one embodiment, for example, a pair of battery cells 119 that are neighboring in the array direction may be connected in parallel and the plurality of neighboring battery cells 119 may be connected in series, such that a voltage of the battery unit 110 may be adjusted to a desired level. For example, the battery unit 110 may include the battery cells 119 each with the voltage of 4.2V and may connect in series three pairs of the neighboring battery cells 119 that are connected in parallel, such that the battery unit 110 may set the voltage of 12.6V.

Referring to FIGS. 2 and 4, the battery pack includes a diode unit 120 disposed on the charge and discharge pathways of the battery unit 110 to control the flow of the charge and discharge. In one embodiment, for example, the diode unit 120 may include at least one charge diode 121 disposed on the charge pathway and at least one discharge diode 122 disposed on the discharge pathway. However, the present invention is not limited thereto, and, in another embodiment, for example, the diode unit 120 may include at east one charge diode 121 only or at least one discharge diode 122 only.

The charge diode 121 may be prepared in plural and connected in series, in parallel, or in series and parallel. For example, the charge diode 121 may be interposed between an external power source (not shown) and the battery unit 110 to perform a function of power conversion, and each of a plurality of charge diodes 121 may be connected in series to induce a voltage drop that corresponds to the difference in voltage levels required from the external power source (not shown) and the battery unit 110, respectively.

The discharge diode 122 may be prepared in plural and connected in series, in parallel, or in series and parallel. For example, the discharge diode 122 may be interposed between an external load (not shown) and the battery unit 110, and each of the plurality of discharge diodes 122 may be connected in parallel to reduce a voltage drop across the plurality of discharge diodes 122. According to another embodiment of the present invention, the discharge diodes 122 are interposed between an external load (not shown) and the battery unit 110 to perform a function of power conversion, and the discharge diodes 122 may be connected in series to induce a voltage drop that corresponds to the difference in voltage levels required from the external load and the battery unit 110, respectively.

As illustrated in FIG. 1, the diode unit 120 may include a supporting plate 125 to support the charge diode 121 and/or the discharge diode 122, and the supporting plate 125 may be prepared in plural. In one embodiment, in a lower part of the supporting plate 125, a flange unit 125a is formed and a base frame 100 may be coupled to the flange unit 125a. The supporting plate 125 may include a circuit board, a metal plate, or the like where the charge diode 121 and/or the discharge diode 122 are provided, and the supporting plate 125 may perform a function as a wiring (not shown) that provides charge and discharge pathways, or may support a wiring.

In one embodiment, the diode unit 120 may be disposed neighboring to the battery unit 110, such as at a side of the battery unit 110 opposite to a side at which the BMS 130 is disposed. For example, the BMS 130 may be disposed on a side of the battery unit 110, and the diode unit 120 may be disposed on another side of the battery unit 110.

In one embodiment, an insulating wall 116 is interposed between the battery unit 110 and the diode unit 120. The insulating wall 116 may mutually insulate the battery unit 110 and the diode unit 120 by being interposed therebetween. By forming the insulating wall 116 between the battery unit 110 and the diode unit 120 in such a way, the charge and discharge pathways wherein charge and discharge power of high current flows and the battery unit 110 may be mutually insulated. That is, the diode unit 120 forms the charge and discharge pathways wherein charge and discharge power of high current flow, and thus, the insulating wall 116 insulates the diode unit 120 with the flow of the high current and the battery unit 110 from each other to prevent or substantially prevent damage to the battery unit 110 caused by a short circuit between the pathway of the high current and the battery unit 110.

In one embodiment, for example, the insulating wall 116 may be formed of galvanized steel sheet, and more particularly, electrolyte galvanized iron (EGI). However, the present invention is not limited thereto, and, in other embodiments, a material of the insulating wall 116 may be any of a variety of materials having electrically insulating characteristics suitable to mutually insulate the battery unit 110 and the diode unit 120 by being interposed therebetween.

In one embodiment, the insulating wall 116 that is interposed between the battery unit 110 and the diode unit 120 may be disposed relatively closer to the battery unit 110 than to the diode unit 120 and may be formed in the biased position toward the battery unit 110. For example, the insulating wall 116 may be disposed to contact a portion of the battery unit 110 facing the diode unit 120. The insulating wall 116 may be adhered to the battery unit 110 to sufficiently protect the battery unit 110 from the charge and discharge pathway of the high current.

The insulating wall 116 may ensure the electrical insulation between the battery unit 110 and the diode unit 120, and, in one embodiment, the insulating wall 116 may be extended to surround the battery unit 110. For example, the insulating wall 116 may be extended to surround one end of the battery unit 110 facing the diode unit 120 and opposite side surfaces of the battery unit 110. The insulating wall 116 that surrounds the battery unit 110 may enhance the insulation of the battery unit 110 and may also function as a structural coupling to the plurality of battery cells 119 that form the battery unit 110.

In one embodiment, referring to FIG. 3, the insulating wall 116 may be extended to surround one end of the battery unit 110 facing the diode unit 120 and opposite side surfaces of the battery unit 110, and an end plate 118 may be disposed at the other end of the battery unit 110 and fastened at opposite ends of the insulating wall 116. Therefore, due to the insulating wall 116 and the end plate 118 that are mutually coupled, an outer circumference along the array direction of the battery unit 110 may be restricted, and accordingly, the plurality of battery cells 119 in one column may be structurally coupled. In addition, depending on the restriction of the insulating wall 116 and the end plate 118 that are mutually coupled, a volume expansion of the plurality of battery cells 119, and a swelling according to the charge and discharge operations is suppressed and resistance characteristics are maintained low to prevent or substantially prevent degradation of the electrical properties of the battery unit 110. The insulating wall 116 and the end plate 118 that are mutually coupled may surround the outer circumference, such as the four side surfaces of the battery unit 110 that may be formed in a roughly rectangular shape, to be restricted.

The insulating wall 116 may be generally formed in a plate shape, and, in one embodiment, the insulating wall 116 surrounds the battery unit 110, and a plurality of heat-radiating holes 116″ may be formed in an extension portion 116a that corresponds to opposite side surfaces of the battery unit 110. The plurality of heat-radiating holes 116″ may be formed at intervals along the array direction of the battery unit 110. The heat-radiating holes 116″ allow contact between the plurality of battery cells 119 and outside air having a low temperature to facilitate a quick emission of driving heat generated from the plurality of battery cells 119.

In one embodiment, one side of the insulating wall 116 protrudes downward, and may include a linkage member 116b that is coupled to the base frame 100. For example, the linkage member 116b may be a penetrating hole wherein an engageable section 100a (see FIG. 1) of the base frame 100 is inserted and fixed therein.

According to an embodiment of the present invention, as illustrated in FIG. 3, the insulating wall 116 for insulating between the battery unit 110 and the diode unit 120 may surround opposite side surfaces of the battery unit 110 as well as the portion between the battery unit 110 and the diode unit 120 by extending to the opposite side surfaces of the battery unit 110. The insulating wall 116 insulates the battery unit 110, and, in addition, the insulating wall 116 may suppress the swelling of the plurality of battery cells 119 by a structural coupling to the plurality of battery cells 119. However, the present invention is not limited thereto, and in another embodiment, for example, a restricting member (not shown) may be disposed to surround the battery unit 110 for coupling to the battery unit 110, and, in addition to the restricting member, the insulating wall 116 may be selectively formed between the battery unit 110 and the diode unit 120. For example, on the restricting member that surrounds the battery unit 110, the insulating wall 116 may be attached thereon, and more particularly, the insulting wall 116 may be attached to a portion of the restricting member facing the diode unit 120 that surrounds the battery unit 110. The restricting member may be formed of a conductive metal material, and the insulating wall 116 may be formed of an insulation material such as galvanized steel sheet.

According to another embodiment of the present invention, the insulating wall 116 surrounds the battery unit 110, but at least a portion of the insulating wall 116 facing the diode unit 120 may be insulated to have the electrically insulating characteristics. For example, through surface treatment on a metal-based raw material, the insulation may be selectively and partially located.

As the one end of the insulating wall 116 is coupled to the end plate 118, the plurality of battery cells 119 are coupled together to the insulating wall 116 and the end plate 118. One side of the end plate 118 may be disposed to face an outer surface of the plurality of battery cells 119 that forms one end side of the battery unit 110. The end plate 118 may include a base plate 118a, and a flange unit 118b that is bent in a direction opposite to the battery cell 119 from the base plate 118a and at an edge of the base plate 118a. The base plate 118a may be formed large enough to cover the outer surface of the plurality of battery cells 119.

The flange unit 118b may be bent in the direction opposite to the battery cell 119 at the edge of the base plate 118a. The flange unit 118b may be formed on opposite side surfaces of the base plate 118a. The flange unit 118b may provide a coupling site between the end plate 118 and the insulating wall 116. For example, the insulating wall 116 may be extended along the array direction of the battery unit 110 to surround the battery unit 110, and each end at opposite sides of the extension portion 116a may contact the flange unit 118b on the opposite side surface of the end plate 118. In one embodiment, coupling holes 116′ and 118′ formed on the insulating wall 116 and the flange unit 118b, respectively, where the insulating wall 116 and the end plate 118 are disposed to overlap each other are cross-matched, to then be fastened by using a fastening member 117, such as a bolt and nut.

The battery pack may include the BMS 130 to monitor status of the charge and discharge of the battery unit 110 and to control the charge and discharge operations. In one embodiment, for example, the BMS 130 may be provided on the end plate 118, such as on a side of the end plate 118 opposite to the battery unit 110.

The BMS 130 may monitor status of the charge and discharge of the battery unit 110 and control overall charge and discharge operations. For example, the BMS 130 may collect information on the status of the charge and discharge based on the plurality of battery cells 119, and based on the information, may determine whether there is any malfunction, such as overcharging or overheating in the battery cells 119, or may estimate the magnitude of a charge (e.g., fully charged) before charging and discharging. For example, the BMS 130 may monitor information signaling the status of the battery cells 119 and may estimate a temperature or a voltage thereof. The BMS 130 may include a circuit board 131 and a plurality of electrical devices 135 provided on the circuit board 131.

Referring to FIG. 1, in one embodiment, with regard to the configuration of the battery unit 110, the BMS 130, and the diode unit 120, the BMS 130 is disposed on one side of the battery unit 110, and the diode unit 120 is disposed on the other side of the battery unit 110. For example, the BMS 130 provided on the battery unit 110 may be assembled on the base frame 100, and the diode unit 120 may be assembled apart with a separation gap “g” between the battery unit 110 and the diode unit 120. The diode unit 120 may be assembled on the other side opposite to the BMS 130 of the battery unit 110.

The diode unit 120 and the battery unit 110 may be on the one base frame 100 together. The base frame 100 may modulate the diode unit 120 and the battery unit 110 that are structurally individualized by a structural coupling to the diode unit 120 and the battery unit 110. In addition, the base frame 100 may perform capabilities of a heat insulating board that dissipates heat involved in the charge and discharge operations.

The battery unit 110 and the diode unit 120 may be assembled on the base frame 100, and with regard to the assembly position, the battery unit 110 and the diode unit 120 may be assembled apart at a separation gap “g” from each other. For example, the battery unit 110 and the diode unit 120 may be disposed apart at the separation gap “g” from each other to avoid delivering the driving heat generated from the battery unit 110 directly to the diode unit 120. In addition, by disposing the diode unit 120 wherein the charge and discharge power of the high current is directly input/output apart at the separation gap “g” from the battery unit 110, damage of the battery unit 110 caused by a short circuit between the charge and discharge pathways and the battery unit 110 may be prevented or substantially prevented. For example, when the charge and discharge pathways where the charge and discharge power of the high current flows and the battery unit 110 are shortened, damage of the battery unit 110 is a concern and, therefore, the diode unit 120 and the battery unit 100 that form the charge and discharge pathways may be disposed apart at the separation gap “g” from each other.

When the battery pack receives the charge power from the external power source (not shown) or provides the discharge power to the external load (not shown), connection terminals 101 and 102 that form an electrical connection with the external power source and the external load may be included. The connection terminals 101 and 102 may include first and second connection terminals 101 and 102 having respective polarities opposite to each other.

The charge power supplied from the external power source that is connected with the connection terminals 101 and 102 may be input in the battery unit 100 through the diode unit 120 and then in the plurality of battery cells 119 each connected in series and parallel through the bus bar 115 of the battery unit 110. The diode unit 120 disposed on the charge pathway may include the charge diode 121 to control the flow of power supply. For example, the charge diode 121 may have the charge power in a forward direction and include a diode that has the discharge power in a reverse direction. The charge diode 121 may perform a function of not only controlling the flow of power supply, but also converting the charge power of a first voltage supplied from the external power source into a second voltage required in the battery unit 110. Although not shown in the drawings, a direct current (DC)-direct current (DC) converter for the power conversion may be disposed on the charge pathway.

The discharge power stored in the battery unit 110 may be output to the external load connected with the connection terminals 101 and 102 through the diode unit 120. Herein, the diode unit 120 may be disposed on the discharge pathway, then to include the discharge diode 122 to control the flow of power supply. For example, the discharge diode 122 may have the discharge power in a forward direction and include a diode that has the charge power in a reverse direction. In addition to controlling the flow of the power supply, the discharge diode 122 may perform a function of power conversion, such as converting a third voltage of the discharge power output from the battery unit 110 to a fourth voltage required from the external load.

A safety device (not shown) may be disposed at a neighboring location of the connection terminals 101 and 102. The safety device may restrict or prevent the charge and discharge currents in the case of a malfunction, such as overheating or overcharging. For example, the safety device may include a positive temperature coefficient (FTC), a fuse, a current blocking device, or the like.

Although not shown in the drawings, the battery pack may further include a battery housing that forms an appearance of the battery pack, and, for example, the battery housing may be formed on the base frame 100 to accommodate the battery unit 110 and the diode unit 120 together from the upper portion of the base frame 100 where the battery unit 110 and the diode unit 120 are provided. The battery housing may perform capabilities of insulating the internal configuration of the battery pack from the external environment. Herein, the connection terminals 101 and 102 are formed to be exposed to the outside of the battery housing to allow an electrical connection with the external power or the external load.

Referring to FIG. 3, the battery unit 110 may include the plurality of battery cells 119 that are electrically connected to each other through the bus bar 115 and may have a structure with connection in series and in parallel. In one embodiment, for example, the battery unit 110 has the plurality of battery cells 119 each connected in parallel in pairs, and three pairs of the neighboring battery cells 119 may be connected in series.

The bus bar 115 is used for the connection of the plurality of battery cells 119 in series or in parallel, and along the array direction of the battery cells 119, the bus bar 115 may electrically connect the first and the second electrode terminals 111 and 112 by extending across the upper portion of the battery cells 119. In one embodiment, for example, the bus bar 115 may be inserted and assembled on the first and the second electrode terminals 111 and 112 through a fastening hole 115′ and may be fixed on the first and the second electrode terminals 111 and 112 and fastened by a fastening member, such as a nut.

According to an aspect of embodiments of the present invention, the insulation structure designed to ensure the electrical insulation between the battery unit and the charge and discharge pathways where the high current flows is provided such that damage or malfunction of the battery unit caused by a short circuit between the battery unit and the charge and discharge pathways may be prevented or substantially prevented.

Furthermore, the insulation structure structurally couples the plurality of battery cells forming the battery unit and additionally performs a function to suppress the swelling of each of the battery cells depending on the operation. Therefore, the whole battery unit may be structurally modulated, and a degradation of electrical characteristics that is associated with the volume expansion of each of the battery cells may be prevented or substantially prevented.

While the present invention has been particularly shown and described with reference to some exemplary embodiments thereof, it will be understood by those of ordinary skill in the art that various changes in form and details may be made therein without departing from the spirit and scope of the present invention as defined by the following claims. Descriptions of features or aspects within each embodiment should typically be considered as available for other similar features or aspects in other embodiments.

What is claimed is:

1. A battery pack comprising:
a battery unit;
a diode unit on charge and discharge pathways to control power flow of the charge and discharge pathways; and
an insulating wall between the battery unit and the diode unit and mutually insulating the battery unit and the diode unit.

2. The battery pack of claim 1, wherein the insulating wall is relatively closer to the battery unit than to the diode unit.

3. The battery pack of claim 2, wherein the insulating wall contacts the battery unit.

4. The battery pack of claim 1, wherein the insulating wall surrounds the battery unit.

5. The battery pack of claim 4, wherein the insulating wall surrounds an end of the battery unit facing the diode unit and opposite side surfaces of the battery unit.

6. The battery pack of claim 5, wherein the insulating wall comprises an extension portion surrounding the opposite side surfaces of the battery unit, and wherein the opposite side surfaces comprise a heat-radiating hole.

7. The battery pack of claim 5, wherein the insulating wall is coupled to an end plate at another end of the battery unit opposite the end of the battery unit facing the diode unit.

8. The battery pack of claim 7, wherein the insulating wall and the end plate are mutually coupled to surround an outer circumference of the battery unit.

9. The battery pack of claim 8, wherein the insulating wall and the end plate surround four side surfaces of the battery unit formed in a rectangular shape.

10. The battery pack of claim 7, wherein the end plate comprises:
a base plate facing the another end of the battery unit; and
a flange unit bent in a direction opposite to the battery unit at an edge of the base plate.

11. The battery pack of claim 10, wherein the flange unit and the insulating wall overlap each other and are mutually fastened by a fastening member.

12. The battery pack of claim 1, wherein the battery unit and the diode unit are spaced apart from each other by a separation gap.

13. The battery pack of claim 1, wherein the battery unit and the diode unit are assembled on a base frame.

14. The battery pack of claim 1, wherein the diode unit comprises:
at least one charge diode formed on the charge pathway of the battery unit; and
at least one discharge diode formed on the discharge pathway of the battery unit.

15. The battery pack of claim 1, further comprising a battery management system (BMS) to control charge and discharge operations of the battery unit.

16. The battery pack of claim 15, wherein the BMS is at a side of the battery unit, and the diode unit is at another side of the battery unit opposite to the BMS.

17. The battery pack of claim 16, wherein the BMS is on an end plate that is at one end of the battery unit.

18. The battery pack of claim 1, wherein the insulating wall is formed of galvanized steel sheet.
